(19) United States
(12) Patent Application Publication
(10) Pub. No.: US 2011/0275548 A1
(43) Pub. Date: Nov. 10, 2011

(54) ANTICORROSIVE AGENT

(75) Inventors: Werner Handl, Altdorf (DE); Franz Mayr, Graz (AT)

(73) Assignee: MAGNA STEYR FAHRZEUGTECHNIK AG & CO KG, Graz (AT)

(21) Appl. No.: 13/123,429

(22) PCT Filed: Oct. 12, 2009
(86) PCT No.: PCT/EP2009/063295

§ 371 Date: Jun. 24, 2011

(30) Foreign Application Priority Data
Oct. 10, 2008 (DE) 102008051264.8

(51) Int. Cl. C10M 125/02; C09K 3/00

(52) U.S. Cl. 508/125; 252/389.4; 252/389.3; 252/389.41

(57) ABSTRACT

The invention relates to an anticorrosive agent for metal components. In order to provide an environmentally compatible anticorrosive agent which can be applied to metal components without components having to be freed of the anticorrosive agent before installation, allows good coating even on oily surfaces, has a great anticorrosive effect and is also compatible with aqueous lubricant compositions, it is provided according to the invention that the anticorrosive agent comprises (in percent by weight): a) more than 50% water, b) a surfactant; c) a boric acid derivative; d) a platelet-like or rod-like filler; e) optionally a binder; f) optionally a carboxylic acid salt.

The invention relates to a corrosion protection composition (anticorrosive agent) for metal components.

A corrosion protection coating on a metal component, especially a component containing a high content of iron, e.g. a steel component, is intended to protect the component against oxidative corrosion and be environmentally compatible.

In addition, it is frequently required of a corrosion protection composition that is intended to be used for manufacturing corrosion protection coatings on metal components, that it neither interferes after the component has been installed in machines or units nor does it have to be removed prior to installation, which is laborious and therefore undesirable. In this regard, it can also be required, in so far as aqueous lubricant compositions are used for individual components, that the corrosion protection composition or the corrosion protection coating be compatible with such lubricant compositions, e.g. those according to the printed publication WO 2007/098523 A2.

According to the prior art, corrosion protection coatings mostly consist of oily or oil- or fat-based coatings. These coatings are frequently paraffinic, naphthenic or aromatic mineral oils or even synthetic or naturally occurring fats or oils. These known corrosion protection coatings serve to seal a surface of components up by means of an oil or fat layer against moisture and oxidative attack. In the course of or after installation of the components protected in this manner, in many cases the corrosion protection coatings are objectionable and therefore undesirable. Consequently, the components are mostly subjected to degreasing and cleaning in laborious processes prior to being installed. This leads not only to considerable environmental pollution but also to noticeable additional costs.

Aqueous corrosion protection compositions that comprise carboxylic acids and phosphate esters are also known from the prior art. Such corrosion protection compositions are intended to delay an oxidative attack on metal components, but are not or only insufficiently compatible with aqueous lubricant compositions.

An aqueous corrosion protection composition that can be utilized for steel components is known from the printed publication JP 2003013263 A. This printed publication discloses a water-based corrosion protection composition that in addition to water and additives such as surfactants and thickeners, e.g. kaolin, clay or mica, comprises pigments that are intended to afford a corrosion protection. The pigments that consist of e.g. phosphates, such as zinc phosphate or magnesium phosphate, possess a mean particle size of maximum 3 μm. According to the teaching of this printed publication, a small mean particle size of the pigments is selected in order that the pigments do not agglomerate. A corrosion protective action of such a corrosion protection composition is essentially exclusively based on the effect generated by the pigments and is insufficient for a sustained corrosion protection. Moreover, it cannot be excluded, in spite of the small particle size, that the pigments in question agglomerate.

The object of the invention is to provide a corrosion protection composition of the type cited in the introduction which permits a good coating of metal components, optionally even oiled or greased metal components, wherein the corrosion protection composition or a corrosion protection coating prepared from it neither has to be removed prior to installing the component nor interferes after the installation and wherein the corrosion protection composition or the corrosion protection coating prepared from it exhibits a great corrosion protection, is environmentally friendly and is compatible with an aqueous lubricant liquid.

This object is achieved by a corrosion protection composition that includes (in weight percent):
a) more than 50% water;
b) a surfactant;
c) a boric acid derivative;
d) a platelet-like or rod-like filler;
e) optionally a binder;
f) optionally a carboxylic acid salt.

The advantages afforded by a corrosion protection composition according to the invention are in particular that said composition enables an aqueous corrosion protection coating for metal components to be manufactured which exhibits a double corrosion protection effect. Firstly, the platelet-shaped or rod-shaped filler, whose particles possess a very high aspect ratio, i.e. a high ratio of particle diameter or particle length to particle thickness, seals up the component as a result of accretion of particles on the surface, such that very long diffusion paths are created for corrosively acting substances that come into contact with the coated surface. In this way a physically efficient corrosion protection mechanism is obtained. Secondly, a boric acid derivative is provided, for example a reaction product of boric acid anhydride with triethanolamine, such that a chemically efficient corrosion protection mechanism is also obtained. In particular, in combination with the provided fillers, it has been shown that a corrosion protection coating can be prepared that possesses no or only a small number of capillary channels for gases such as air, and the coated surface also protects in a chemical manner. Thus the surface is not only virtually diffusion tight, but also chemically passivated. It is also advantageous that the corrosion protection composition according to the invention is fully compatible with aqueous or water-containing lubricants liquids or cooling liquids, wherein in regard to aqueous lubricant liquids, it has been surprisingly observed that a lubrication effect is increased through the interaction of a corrosion protection composition in the form of a corrosion protection coating with aqueous lubricant liquids, because the corrosion protection composition lowers the coefficient of friction.

In the context of the invention, in order to obtain a corrosion protection coating that is as tight as possible with no or essentially no capillary channels, it is preferred that the corrosion protection composition includes a platelet-shaped filler. Particularly suitable fillers are selected from the group consisting of graphite, mica, hexagonal boron nitride, talc, kaolin and iron mica. In this regard, it has also proven advantageous for the average particle diameter of the platelet-shaped filler to be smaller than 15 μm, preferably smaller than μm, especially smaller than μm. An average particle diameter is preferably from 0.5 to 5.0 μm.

In principal, any substances, which reduce the surface tension, can be employed as a surfactant. However, in order to reduce both a static as well as a dynamic surface tension, it is preferred to employ an acetylenic derivative for wetting oil- or fat-containing surfaces, acetylene glycol being preferred. These types of surfactant or wetting agents have the advantage that good wetting power can be achieved without one having to worry about toxic or environmentally damaging side effects. Moreover, the use of acetylenic derivatives enables a corrosion protection composition to be produced with a particularly high corrosion protection action, even though the interaction of this component with the other active corrosion protection components of the corrosion protection composition has not yet been elucidated.

A binder from the group of the polysaccharides can be admixed with the corrosion protection composition in order to improve the adhesion and abrasion resistance.

Furthermore, in a corrosion protection composition according to the invention it has proven advantageous to provide a carboxylic acid salt, selected from the group consisting of zinc stearate, calcium stearate, aluminum stearate, zinc oleate, calcium oleate and aluminum oleate.

In accordance with the abovementioned exemplifications, a corrosion protection composition according to the invention is essentially free of phosphates thereby presenting another advantage in regard to environmental compatibility.

In order to promote compatibility with aqueous lubricant compositions, the corrosion protection composition can also include more than 80%, preferably more than 90%, of water.

The filler content can be chosen as desired over a broad range. A preferred range, which ensures a high corrosion protection action, but which also allows the corrosion protection agent to be easily processed or easily deposited onto metal components, is between 0.5 to 30%, preferably 0.5 to 5.0%.

The quantity of the surfactant in the corrosion protection composition is preferably in the range 0.1 to 2.0%. The advantages of the surfactant are fully exploited in this range. At lower concentrations, under certain circumstances, a desired action of the surfactant may not be obtained. Concentrations higher than 2.0% may also prove to be disadvantageous.

In order to achieve a desired chemical corrosion protection action in the best possible way, preferably 0.5 to 10% of the boric acid derivative are added, e.g. a reaction product of boric acid anhydride with triethanolamine or another amine ester of boric acid.

In accordance with the advantages of a corrosion protection composition according to the invention, said composition is preferably utilized for components made of a steel alloy. The corrosion protection composition can be applied by any technique, especially by dipping a component or by spraying the corrosion protection composition onto the component.

The invention is explained below in still more detail with the help of exemplary embodiments.

### EXAMPLE 1

In a stirred vessel equipped with a dissolver disk were placed 90.5 liter of demineralized water, and 0.5 g acetylene glycol were added. 3.5 kg of methyl cellulose (Höppler viscosity 300 mPas 2% conc.) were then dissolved therein. Subsequently, 2.0 kg graphite (d₅₀ 4.0 μm, 99.5% carbon) and 3.5 kg of a boric acid derivative, manufactured by treating boric acid anhydride with triethanolamine, were added. This mixture was then homogenized by means of a dispersion device. After homogenization, steel components were sprayed with the thus prepared corrosion protection composition or dipped into it. After drying, a tightly sealed coating is formed which protects the part against oxidative attack and which is extremely compatible with aqueous lubricant compositions.

### EXAMPLE 2

As per the method in example 1, 2.0 kg polyvinyl alcohol (fully hydrolyzed, Höppler viscosity 30 mPas 2% conc.) were dissolved in 92.0 liter of demineralized water, and 0.5 kg acetylene glycol were added. Subsequently, 2.5 kg graphite (d₅₀ 4.0 μm, 99.5% carbon), 2.0 kg zinc stearate and 1.0 kg boric acid derivative (manufactured as per example 1) were added The thus prepared corrosion protection composition can be utilized as in example 1.

### EXAMPLE 3

As per the method in example 1, 0.5 kg acetylene glycol were added to 90.0 liter of demineralized water. 3.5 kg of methyl cellulose (Höppler viscosity 300 mPas 2% conc.) were then dissolved therein. 2.5 kg mica powder (d₅₀ 2.0 μm) were then added and 3.5 kg boric acid derivative (prepared as in example 1) were dissolved. The corrosion protection composition can be utilized as in example 1.

1. A corrosion protection composition, comprising (in weight percent):
a) more than 50% water;
b) a surfactant;
c) a boric acid derivative; and
d) a platelet-like or rod-like filler.

2. The corrosion protection composition according to claim 1, comprising a platelet-shaped filler.

3. The corrosion protection composition according to claim 2, wherein the platelet-shaped filler is selected from the group consisting of graphite, mica, hexagonal boron nitride, talcum, kaolin and iron mica.

4. The corrosion protection composition according to claim 3, wherein an average particle diameter of the platelet-shaped filler is less than 15 μm.

5. The corrosion protection composition according to claim 1, wherein the surfactant is an acetylenic derivative.

6. The corrosion protection composition according to claim 5, wherein the acetylenic derivative is acetylene glycol.

7. The corrosion protection composition according to claim 1, comprising a binder from the group of the polysaccharides.

8. The corrosion protection composition according to claim 1, comprising a carboxylic acid salt selected from the group consisting of zinc stearate, calcium stearate, aluminum stearate, zinc oleate, calcium oleate and aluminum oleate.

9. The corrosion protection composition according to claim 1, wherein the composition is essentially free of phosphates.

10. The corrosion protection composition according to claim 1, comprising more than 80% water.

11. The corrosion protection composition according to claim 1, comprising 0.5 to 30% filler.

12. The corrosion protection composition according to claim 1, comprising 0.1 to 2.0% surfactant.

13. The corrosion protection composition according to claim 1, comprising 0.5 to 10% of the boric acid.

14. A method of use comprising applying a corrosion protection composition according to claim 1 as a corrosion protection coating to components made of a steel alloy.

15. A combination of an aqueous lubricant liquid with a corrosion protection composition according to claim 1.

16. The corrosion protection composition according to claim 1, further comprising a binder.

17. The corrosion protection composition according to claim 1, further comprising a carboxylic acid salt.

18. The corrosion protection composition according to claim 4, wherein an average particle diameter of the platelet-shaped filler is less than 10 μm.

19. The corrosion protection composition according to claim 4, wherein an average particle diameter of the platelet-shaped filler is less than 7.5 μm.

20. The corrosion protection composition according to claim 1, comprising more than 90% water.

21. The corrosion protection composition according to claim 1, comprising 0.5 to 10% of the boric acid derivative which is a reaction product of boric acid anhydride with triethanolamine.
